(19) United States
(12) Patent Application Publication
(10) Pub. No.: US 2016/0161934 A1
(43) Pub. Date: Jun. 9, 2016

(54) System for use in Automation Technology

(71) Applicant: Endress + Hauser Conducta Gesellschaft für Mess- und Regeltechnik mbH + Co. KG, Gerlingen (DE)

(72) Inventors: Bjorn Haase, Stuttgart (DE); Peter Seefeld, Bad Wimpfen (DE); Joachim Schroder, Weil am Rhein (DE); Markus Hoh, Bonvillars (CH)

(21) Appl. No.: 14/957,823

(22) Filed: Dec. 3, 2015

(30) Foreign Application Priority Data
Dec. 4, 2014 (DE) 10 2014 117 894.7

(51) Int. Cl. G05B 19/05; H04W 4/00

(52) U.S. Cl. CPC G05B 19/05; H04W 4/008; G05B 2219/1134

(57) ABSTRACT

A system for use in automation technology, comprising: field devices for measuring and/or controlling a process variable, a server that is connected with the field devices holding a life-list with the field devices that are connected with the server, wherein the life-list contains information for the field devices that is required for establishing a connection with the field devices, and an operator device with not less than one first communication interface, wherein the first communication interface may be used for establishing a connection with the server, in order to retrieve the life-list and the information needed for establishing connections on the operator device, so that a data connection between the operator device and a field device listed in the life-list is possible according to the information.

The invention relates to a system for use in automation technology.

Field devices for recording and/or modifying process variables are frequently used in process automation technology as well as in manufacture automation technology. Measuring devices or sensors, such as level measuring devices, flow meters, pressure and temperature measuring devices, pH-redox potential meters, conductivity meters etc., are used for recording the respective process variables such as fill level, flow, pressure, temperature, pH level and conductivity. Actuators, such as e.g. valves or pumps, are used to influence process variables. Thus, the flow rate of a fluid in a pipeline section or a filling level in a container can be altered by means of actuators.

Field devices in general refer to all devices which are process-oriented and which provide or edit process-relevant information. In addition to the aforementioned measuring devices/sensors and actuators, units that are directly connected to a field bus and used for communication with superordinate units, such as e.g. remote I/Os, gateways, linking devices and wireless adapters, are also generally referred to as field devices.

The company group Endress+Hauser offers and distributes a large variety of such field devices.

In modern industrial plants, field devices are usually connected with superordinate units via field bus systems, such as e.g. Profibus®, Foundation Fieldbus®, HART®, etc. Usually, the superordinate units are control systems or control units, such as e.g. a SPC (Stored Program Control) or a PLC (Programmable Logic Controller). The superordinate units are used, among other things, for process control, process visualization, process monitoring as well as commissioning of the field devices. The values recorded by field devices, sensors in particular, are transmitted via the connected bus system to one or possibly even multiple superordinate unit(s). In addition to that, data transfer from the superordinate unit to the field devices via the bus system is required; in particular, it serves the purpose of configuration and parameterization of field devices as well as diagnostics. In general terms, the field device is operated via the bus system from the superordinate unit.

In addition to the wired data transfer between the field devices and the superordinate unit, there is likewise a possibility for wireless data transmission. In the bus systems Profibus®, Foundation Fieldbus® and HART® in particular, a wireless radio-based data transfer is specified. Moreover, radio networks for sensors are specified in the standard IEEE 802.15.4 in more detail. The IEEE standard only describes the two lower layers (PHY and MAC) in the ISO-OSI model for WPANs (Wireless Personal Area Networks). The higher protocol layers are regulated by other organizations. This enables universal use of the IEEE 802.15.4 base layer. A multitude of different technologies are using this base layer while extending the protocol stack only on the higher layers. Thus, a basis for IP based sensor networks was created by means of the IETF standard 6LoWPAN, for example.

To enable wireless data transfer, current field devices have multiple radio interfaces, such as e.g. WLAN, Bluetooth, and/or near field communication (NFC). These interfaces can be used to establish a connection to the respective field device, in order to enable access to its process data and/or field device data or parameters.

For this kind of data transfer, typically operating devices, preferably mobile operating devices, are used, which are also fitted with multiple radio interfaces. Such operating devices can be e.g. proprietary devices as well as newer devices such as, for example, smartphones, notebooks or iPads. Depending on the radio interface, different wireless standards and technologies using different protocols are used with these devices.

Depending on the interface type and the protocol used, the operators need to know how to use these different connection and communication technologies in order to get connected. Especially when it comes to direct on-site operations, different field devices with different interfaces have to be operated within a very short period of time. This results in the operators having to bring respective hardware and software equipment along with them, having to have a great amount of expertise on how to use the technology-specific interfaces for access and having to spend much time for the set-up of the different connections.

To make things more complicated, with wireless connections it is optically not clearly visible for the operator, which wireless protocol (e. g. WLAN, Bluetooth, 6LoWPan) is available for certain field devices. This complicates the operation, poses possible error sources and results in significant loss of time for the operator, when it comes to practically using such field devices and operator devices.

The invention is based on the goal of creating increased ease of operation for field units with different radio interfaces by means of an operator device.

The goal is achieved according to the invention by a system for use in automation technology, comprising:
field devices for measuring and/or controlling a process variable,
a server that is connected with the field devices holding a life-list with the field devices that are connected with the server, wherein the life-list contains the information needed for establishing a connection with the field devices,
an operator device with not less than one first communication interface, wherein the first communication interface may be used for establishing a connection with the server, in order to retrieve the life-list and the information needed for establishing connections on the operator device, so that a data connection may be established between operator device and a field device listed in the life-list by using the information.

A life-list in this context is a list comprising all field devices that are connected to a server, e.g. via a field bus, and thus accessible.

According to the invention, a life-list is envisaged comprising not only the field devices contained in an automation plant, but also all the specific information that is needed for establishing a connection with one of the field devices listed in the life-list. In particular, the life-list contains all the information needed by the operator device for establishing a data connection with each of the field devices listed in the life-list, without the need for a manual operation by the user (operator), or without the user having to create a manual configuration for the respectively used communication interface.

In an advantageous embodiment of the system according to the invention, the information would comprise not less than one of the following pieces of information:
a name of the field device,
an IP address of the field device,
an IP address of a gateway, which provides a connection to a field device,
an alternative way of communication with the field device.

In an advantageous embodiment of the system according to the invention, it is envisaged that field devices are used that enable a direct connection with the operator device, and wherein the operator device has a second communication interface, which enables the direct connection between operator device and field device to be established, so that a direct data transfer may be realized. In particular, it is envisaged in this embodiment that the operator device performs a scan via the second communication interface detecting all the existing field devices that are within reach and wherein the operator device creates a local life-list comprising all field devices located within reach of the second communication interface of the operator device. In particular, it is likewise envisaged in this embodiment that the operator device combines the life-list contained on the server and the local life-list resulting from the scan into a complete life-list. Furthermore, the embodiment may provide for the second communication interface to be a Bluetooth and/or a near field communication interface.

In this context, it may happen that a field device is listed in the local life-list as well as in the life-list that is held on the server. If a connection is to be established to such a field device, the operator device can now perform an evaluation as a basis for the decision, in which way the connection to the field device should be established. This may happen without further intervention from a user or an operator. One possible evaluation criterion could be, e.g. energy consumption. Thus, a software component contained on the operator device, e.g. a connection manager, can automatically choose a connection type that, for example, requires lower energy consumption.

For the user of the operator device, the life-list is processed on the operator device via a HM-interface (Human-Machine-Interface) in such a way that no time consuming intervention from the user or operator is required in order to choose and respectively configure the communication interface to be used.

In a preferred embodiment of the system according to the invention, it is envisaged for the server to be an access point or a router, and for the field devices to create an IP-based field device network.

In a preferred embodiment of the system according to the invention, it is envisaged for the first communication interface of the operator device to be a LAN interface.

In a preferred embodiment of the system according to the invention, it is envisaged that the field devices connected with the server would be connected via Ethernet or 6LowWPAN.

In this context, 6LowWPan designates a specification based on IEEE 802.15.4 that is designed to enable a more efficient communication of IPv6 data packets via IEEE 802.15.4 networks. The acronym stands for “IPv6 over Low power WPAN (Wireless Personal Area Network). The advantages of 6 LowWPan are a better embedded integration than IEEE 802.11 WLAN and simultaneously a 100 times lower energy consumption.

The invention is further illustrated referring to the following drawings. Illustrated are:

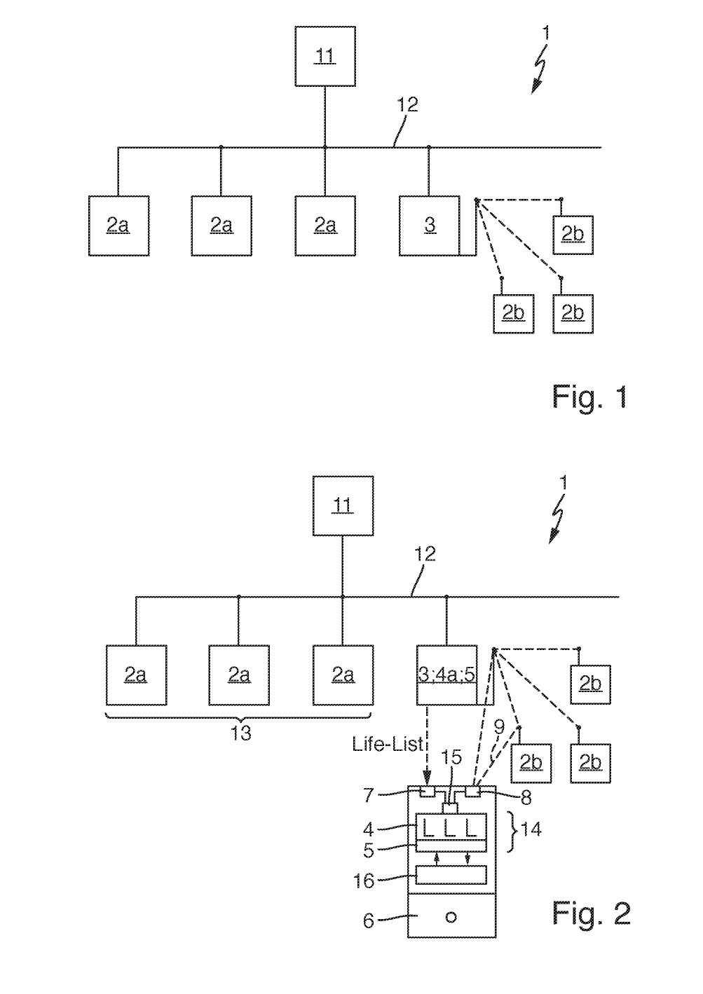

FIG. 1: a system from automation technology known from prior art, and

FIG. 2: a system for use in automation technology according to the invention.

FIG. 1 shows a system 1 for use in automation technology known from prior art. The system 1 comprises a superordinate unit 11 that is connected with the wired field devices 2a via a field bus 12, e.g. Ethernet. The superordinate unit 11 is additionally connected with a gateway 3 that functions as an access point for wireless field devices 2b. The superordinate unit 11, in connection with the wired field devices 2a, comprises a host system 13. The wireless field devices 2b are connected to the host system 13 via the gateway 3, which functions as a system interface between the host system 13 and the wireless network, e.g. a 6LowWPAN network.

FIG. 2 shows a system 1 for use in automation technology according to the invention. In addition to the components described above in FIG. 1, the System 1 according to the invention also comprises an operator device 6. The operator device 6 may, for example, be an iOS Tablet with WLAN as first communication interface and Bluetooth and/or Bluetooth LE (Low Energy) as second communication interface. Such an operator device 6 can switch its communication interfaces 7, 8 between different operating modes, in this case between WLAN and Bluetooth, in a multiplexed way.

In this embodiment example, the gateway 3 does not only function as system interface, but likewise as server 3, on which the life-list 4a with the field devices 2a contained within the host system 13 and the wireless field devices 2b connected via the gateway is held. Thus, the gateway 3 has a double function, serving as system interface as well as server 3.

In addition to this embodiment example, other embodiment examples are possible, in which the gateway 3 would function exclusively as system interface and an additional server 3 is provided, e.g. in the form of a personal computer (PC), wherein on the server 3 or the personal computer, the life-list 4a with all field devices 2 accessible via the Ethernet 12 and the wireless network are managed.

This life-list contains all the information 5 required for establishing connections with the respective field devices. Such information may e.g include:
a name of the field device 5a;
an IP address of the field device 5b;
an IP address of a gateway 5c, which provides a connection to a wireless field device 2b;
an alternative way of communication 5d that can be used for data exchange between the field device and the operator device;
device type of the field device;
software versions of the field device;
protocol type.

Three software components 14, 15, 16 run on the operator device 6. A first software component 14, which manages a comprehensive life-list 4 bringing together the local life-list 4b identified by the second software component 15 and the life-list 4a from the server 3 identified by the third software component 16. The second software component 15 performs a scan in order to identify the local life-list 4b, so that all wireless field devices 2b that are within reach of the second communication interface 8 are identified. The third software component 16 that runs on the operator device 6 establishes a connection to the server 3 and retrieves from it the life-list 4a that is held there with information about the otherwise accessible field devices, e.g. the wireless field devices 2b that are accessible via the gateway.

The operator device 6 processes the local life-list 4b for the user and provides the user with the possibility of establishing a connection with the desired field device via the Human-Machine-Interface, without having to enter information about the required communication channels.

Optionally, information about the spatial position of the field devices 2 within the plant may also be kept in the life-list 4. In this way, when choosing the desired field device 2, the user can be provided with exact directions as to where the field device 2 is located.

### LIST OF REFERENCE NUMBERS

1 System
2a field devices of the host system
2b field devices that enable a direct connection with the operator device, e.g. wireless field devices
3 server, access point, gateway, etc.
4 life-list
5 information needed for establishing a connection
6 operator device
7 first communication interface
8 second communication interface
9 direct connection
10 local life-list
11 superordinate unit
12 field bus
13 host system
14 first software component
15 second software component
16 third software component

1-9. (canceled)

10. A system for use in automation technology, comprising:
field devices for measuring and/or controlling a process variable;
a server that is connected with said field devices holding a life-list with said field devices that are connected with said server, said life-list contains information for said field devices that is required for establishing a connection with said field devices; and
an operator device with not less than one first communication interface, wherein:
said first communication interface may be used for establishing a connection with said server, in order to retrieve said life-list and said information needed for establishing connections on said operator device, so that a data connection between said operator device and said field device listed in said life-list is possible by means of said information.

11. The system according to claim 10, wherein:
said information shall include not less than one of the following pieces of information:
a name of the field device;
an IP address of the field device;
an IP address of a gateway, which provides a connection to a field device; and
an alternative way of communication with said field devices.

12. The system according to claim 10, wherein:
said field devices are used that enable a direct connection with said operator device; and
said operator device has a second communication interface, which enables said direct connection between said operator device and said field device to be established, so that a direct data transfer may be realized.

13. The system according to claim 12, wherein:
said operator device performs a scan via said second communication interface detecting all said existing field devices that are within reach; and
said operator device creates a local life-list comprising all said field devices located within reach of said second communication interface of said operator device.

14. The system according to claim 13, wherein:
said operator device combines said life-list contained on the server and said local life-list resulting from the scan into a complete life-list.

15. The system according to claim 12, wherein:
said second communication interface is a Bluetooth and/or a near field communication interface.

16. The system according to claim 10, wherein:
said server is an access point or a router and the connected field devices create an IP-based field device network.

17. The system according to claim 10, wherein:
said first communication interface of said operator device is a radio interface, in particular, a WLAN interface.

18. The system according to claim 10, wherein:
said field devices connected with said server are connected with said server via Ethernet or 6LowWPAN.
